(19) United States
(12) Patent Application Publication
(10) Pub. No.: US 2026/0316186 A1
(43) Pub. Date: Oct. 15, 2026

(54) METHOD OF MANUFACTURING METAL MEMBER

(71) Applicant: FUTABA INDUSTRIAL CO., LTD., Okazaki-shi (JP)

(72) Inventor: Hiromu Nakao, Okazaki-shi (JP)

(21) Appl. No.: 19/576,957

(22) Filed: Mar. 24, 2026

(30) Foreign Application Priority Data
Apr. 14, 2025 (JP) 2025-066411

(51) Int. Cl. B23K 26/34

(52) U.S. Cl. CPC B23K 26/34

(57) ABSTRACT

A method of manufacturing a metal member includes irradiating a hardening region of the metal member with a beam. The hardening region includes a ridgeline portion on an outer peripheral surface of the metal member. The ridgeline portion extends along a ridgeline of the metal member. A cross section of the ridgeline portion perpendicular to the ridgeline located at an apex of the cross section is curved such that the outer peripheral surface is convex. The hardening region includes therein an irradiation area, where the beam is irradiated. The irradiation area moves along an irradiation path that passes across the ridgeline portion and that includes at least one crossing segment that crosses the ridgeline. The hardening region and the irradiation area are rectangular when viewed in a shortest direction along an imaginary straight line connecting a light source of the beam and the ridgeline at a shortest distance.

### CROSS-REFERENCE TO RELATED APPLICATIONS

This application claims the benefit of Japanese Patent Application No. 2025-066411 filed on Apr. 14, 2025 with the Japan Patent Office, and the entire disclosure of Japanese Patent Application No. 2025-066411 is incorporated herein by reference.

### BACKGROUND

The present disclosure relates to a method of manufacturing a metal member.

Japanese Unexamined Patent Application Publication No. 2016-194132 discloses that a hardening region of a metal member is irradiated with a beam during a process of manufacturing the metal member. An irradiation area in the hardening region is irradiated with the beam. The irradiation area moves along an irradiation path.

### SUMMARY

As described in Japanese Unexamined Patent Application Publication No. 2016-194132, when the metal member to be hardened includes a ridgeline portion extending along a ridgeline of the metal member, a region on an outer peripheral surface of the metal member that includes the ridgeline portion may be set as the hardening region. The shape of the hardening region may be set to be rectangular when viewed along an imaginary straight line connecting a light source of the beam and the ridgeline at a shortest distance. A beam that produces a circular outer shape for the irradiation area may be used.

In such a case, the shape of the hardening region is rectangular, whereas the outer shape of the irradiation area is circular, and thus, the irradiation area may need to extend outside the hardening region in order to cause the entire hardening region to reach a required hardening temperature. In this case, additional thermal energy is required for a portion of the irradiation area extending outside the hardening region. This may result in reduced heating efficiency of hardening.

One aspect of the present disclosure provides a technique capable of improving a heating efficiency of hardening in a method of manufacturing a metal member.

One aspect of the present disclosure is a method of manufacturing a metal member, and the method comprises irradiating a hardening region of the metal member with a beam. The hardening region includes a ridgeline portion on an outer peripheral surface of the metal member. The ridgeline portion extends along a ridgeline of the metal member. A cross section of the ridgeline portion perpendicular to the ridgeline has a curved shape such that the outer peripheral surface is convex. The ridgeline is located at an apex of the cross section. The hardening region includes therein an irradiation area, where the beam is irradiated. The irradiation area moves along an irradiation path. The irradiation path passes across the ridgeline portion. The irradiation path includes at least one crossing segment that crosses the ridgeline. The hardening region has a rectangular shape when viewed in a shortest direction. The shortest direction is a direction along an imaginary straight line connecting a light source of the beam and the ridgeline at a shortest distance. The irradiation area has an outer shape that is rectangular when viewed in the shortest direction.

With this configuration, a heating efficiency of hardening can be improved by the method of manufacturing a metal member.

In one aspect of the present disclosure, the irradiation area may include an outer peripheral portion and a central portion. The outer peripheral portion forms an outer peripheral edge of the irradiation area. The central portion is surrounded by the outer peripheral portion. An intensity of the beam in the central portion may be lower than an intensity of the beam in the outer peripheral portion. With this configuration, the heating efficiency of the hardening can be further improved by the method of manufacturing a metal member.

In one aspect of the present disclosure, the irradiation area may move along the irradiation path while repeatedly reciprocating in a direction parallel to the ridgeline. With this configuration, the hardening region can be hardened more uniformly by the method of manufacturing a metal member.

In one aspect of the present disclosure, a speed at which the irradiation area moves may decrease as a distance between the ridgeline and the irradiation area increases. With this configuration, the hardening region can be hardened more uniformly by the method of manufacturing a metal member.

In one aspect of the present disclosure, an output power of the beam may increase as a distance between the ridgeline and the irradiation area increases. With this configuration, the hardening region can be hardened more uniformly by the method of manufacturing a metal member.

### BRIEF DESCRIPTION OF THE DRAWINGS

An example embodiment of the present disclosure will be described hereinafter with reference to the accompanying drawings, in which:

FIG. 1 is a perspective view of a metal member of a first embodiment;

FIG. 2 is an explanatory diagram showing a positioning step of the first embodiment;

FIG. 3 is an explanatory diagram showing beam irradiation from a laser head to the metal member of the first embodiment when viewed along a ridgeline;

FIG. 4 is an explanatory diagram showing a hardening region and an irradiation path of the first embodiment when viewed in a shortest direction;

FIG. 5 is an explanatory diagram showing the irradiation area of the first embodiment when viewed in the shortest direction;

FIG. 6 is an explanatory diagram showing the beam irradiation from the laser head to the metal member of the first embodiment when viewed from a first side portion;

FIG. 7A is an explanatory diagram showing an irradiation path and a passing region when the irradiation area passes through a first leftward crossing segment;

FIG. 7B is an explanatory diagram showing the irradiation path and the passing region when the irradiation area reaches a first terminal end of the first leftward crossing segment;

FIG. 7C is an explanatory diagram showing the irradiation path and the passing region when the irradiation area passes through a first rightward crossing segment;

FIG. 7D is an explanatory diagram showing the irradiation path and the passing region after the irradiation area passes through a plurality of leftward crossing segments, a plurality of rightward crossing segments, and a plurality of connecting segments;

FIG. 8 is an explanatory diagram showing hardening of the metal member when the irradiation area has a circular shape when viewed in the shortest direction;

FIG. 9 is an explanatory diagram showing the hardening of the metal member of the first embodiment;

FIG. 10 is an explanatory diagram showing an irradiation path and a passing region after the irradiation area passes through each of leftward crossing segments, rightward crossing segments, and connecting segments in a second embodiment; and

FIG. 11 is an explanatory diagram showing an irradiation area in a modified example when viewed in the shortest direction.

### DETAILED DESCRIPTION OF EXEMPLARY EMBODIMENTS

### 1. First Embodiment

### [1-1. Overview]

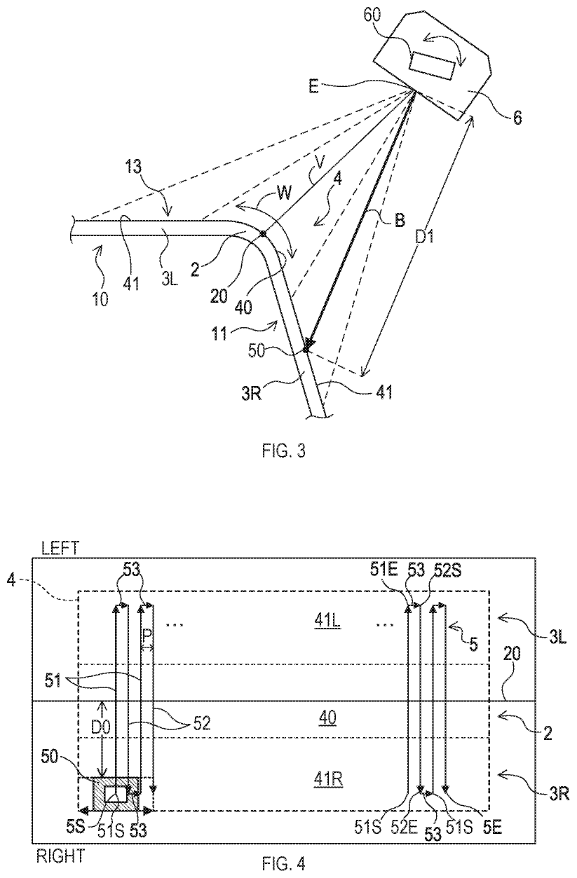

A method of manufacturing a metal member 1 (see FIG. 1) in the first embodiment includes a step of hardening the metal member 1 by a beam B (see FIG. 3). The metal member 1 is a plate-shaped member formed of metal. The metal forming the metal member 1 is, for example, iron. As an example, a material forming the metal member 1 may be high-tensile steel, and more specifically, high-tensile steel having a tensile strength of 590 MPa or greater. As an example, the metal member 1 is used as a portion of a vehicle, and more specifically, a portion of a vehicle body. The metal member 1 may be a member that is not to be mounted in the vehicle.

The metal member 1 is a groove-like member extending along an extending direction S. The metal member 1 comprises a plate-shaped portion 10, a first side portion 11, a first flange 11A, a second side portion 12, and a second flange 12A (see FIGS. 1 to 3).

The plate-shaped portion 10 is an elongated flat plate-shaped portion extending in the extending direction S. A stepped portion 10A extending in the extending direction S is formed in a center part of the plate-shaped portion 10 in a width direction thereof.

The first side portion 11 and the second side portion 12 are flat plate-shaped portions protruding from both ends of the plate-shaped portion 10 in the width direction, respectively. The first side portion 11 and the second side portion 12 face each other in the width direction of the plate-shaped portion 10. The first side portion 11 and the second side portion 12 each extend from a first end to a second end of the plate-shaped portion 10 in the extending direction S.

The first flange 11A and the second flange 12A are flat plate-shaped portions provided at ends of the first side portion 11 and the second side portion 12, respectively, opposite to ends directly connected to the plate-shaped portion 10. The first flange 11A and the second flange 12A extend from the first end to the second end of the first side portion 11 and the second side portion 12, respectively, in the extending direction S.

Specifically, the first side portion 11 and the second side portion 12 form an opening of the metal member 1, which is a groove-like member. The first flange 11A and the second flange 12A are arranged on both sides of the opening in the metal member 1. The plate-shaped portion 10, the first side portion 11, and the second side portion 12 have respective surfaces facing the opening of the metal member 1, and a surface opposite these surfaces forms an outer peripheral surface 13 of the metal member 1.

### [1-2. Ridgeline Portion and Adjacent Portion]

A ridgeline portion 2 extending along a ridgeline 20 is formed at a boundary between the plate-shaped portion 10 and the first side portion 11 (see FIGS. 1 to 3). In the following description and drawings, “left side” refers to the side where the plate-shaped portion 10 is located, and “right side” refers to the side where the first side portion 11 is located, with respect to the ridgeline portion 2. The ridgeline 20 is included in the ridgeline portion 2. The ridgeline 20 extends along the extending direction S. The ridgeline 20 is linear. Specifically, the ridgeline portion 2 extends linearly. The ridgeline portion 2 and the ridgeline 20 each extend from the first end to the second end of the metal member 1. The ridgeline portion 2 has a rectangular shape when viewed in a direction (hereinafter, the “shortest direction”) along an imaginary straight line V connecting an emission position E of a laser device (to be described below) and the ridgeline 20 in the shortest distance (see FIG. 4).

A cross section perpendicular to the ridgeline 20 in the ridgeline portion 2 (hereinafter, simply referred to as “cross section”) has a curved shape such that the outer peripheral surface 13 of the metal member 1 is convex. The cross section of the ridgeline portion 2 has, for example, an arc shape (see FIG. 3). The ridgeline 20 is located at an apex of the cross section.

A length of the ridgeline portion 2 in a ridgeline width direction W, which is a direction along the outer peripheral surface 13 and perpendicular to the extending direction S, is substantially equal to an effective width be of the metal member 1 that is determined based on Karman's effective width concept. As an example, the effective width be can be calculated by Formula 1 below.

$$\text{?} \qquad [ Formula 1 ]$$

$$\text{?} \text{indicates text missing or illegible when filed}$$

In Formula 1, “E” is the Young's modulus of the metal forming the metal member 1; “k” is a constraint factor; “v” is the Poisson's ratio; “σ_{y}” is the yield point (MPa); and “t” is the thickness (mm) of the metal member 1. The length of the ridgeline portion 2 in the ridgeline width direction W is not limited to the effective width be.

Two portions between which the ridgeline portion 2 is arranged from the left and right sides are referred to as an adjacent portion 3L and an adjacent portion 3R, respectively (see FIGS. 1 to 3). The adjacent portion 3L, which is one of the two portions, is a portion of the plate-shaped portion 10 adjacent to the ridgeline portion 2. The adjacent portion 3R, which is the other of the two portions, is a portion of the first side portion 11 adjacent to the ridgeline portion 2. The adjacent portions 3L and 3R are flat plate-shaped portions. The two adjacent portions 3L and 3R extend from the first end to the second end of the metal member 1.

### [1-3. Method of Manufacturing Metal Member]

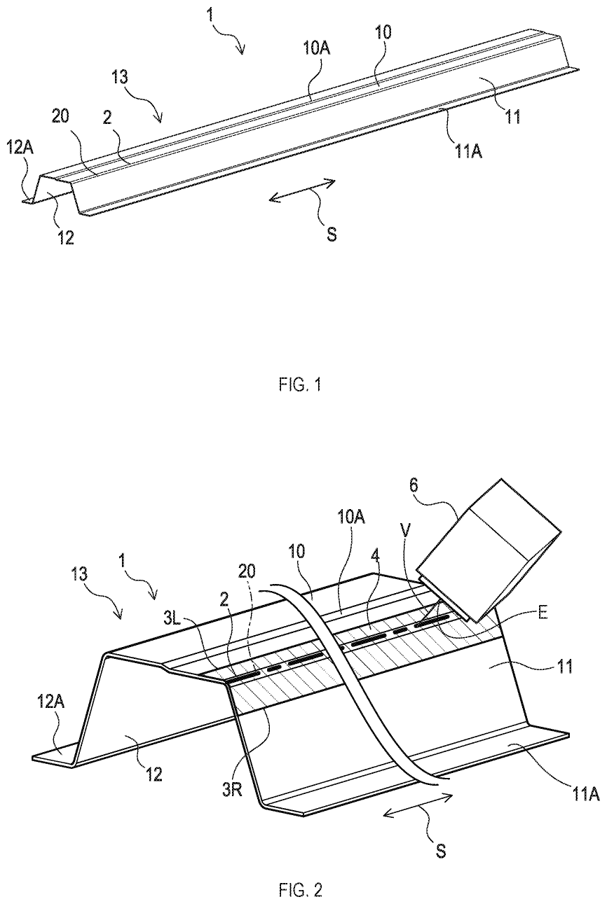

The method of manufacturing the metal member 1 comprises a pressing step of forming the metal member 1 by press-forming, a positioning step of positioning the metal member 1 in the laser device for hardening (see FIG. 2), and a hardening step of hardening the metal member 1 (see FIGS. 3 to 7D). The metal member 1 may be formed by a method other than press-forming.

In the positioning step, the metal member 1 is positioned in the laser device (see FIG. 2). The laser device comprises at least a laser head 6. The laser head 6 includes a light source (not shown) and a galvanometer mirror 60 (see FIG. 3). A laser beam emitted from the light source is reflected by the galvanometer mirror 60, and the reflected laser beam is emitted as the beam B toward the outside of the laser head 6. Hereinafter, a position E where the beam B is emitted from the laser head 6 to the outside is referred to as an “emission position E”. As an example, the laser head 6 is arranged such that the emission position E of the beam B is located on a normal to the ridgeline 20 of the metal member 1. The laser head 6 may be arranged such that the emission position E of the beam B is closest to the ridgeline 20. The laser head 6 can change an emission direction of the beam B through adjustment of an orientation of the galvanometer mirror 60.

In a state where the metal member 1 is positioned in the laser device, the laser head 6 faces a hardening region 4 of the metal member 1 from an outer peripheral surface 13 side. In FIG. 2, the hardening region 4 is hatched. The hardening region 4 extends from the first end to the second end of the metal member 1. The hardening region 4 includes at least the ridgeline portion 2. As an example, the hardening region 4 includes the ridgeline portion 2 and the two adjacent portions 3L and 3R. For example, the hardening region 4 may include only one of the adjacent portion 3L or the adjacent portion 3R, or may include both adjacent portions 3L and 3R. The ridgeline 20 is located substantially centrally in left and right directions of the hardening region 4. The hardening region 4 has a rectangular shape when viewed in the shortest direction (see FIG. 4).

In the hardening step, the hardening region 4 is irradiated with the beam B. The hardening region 4 includes therein an irradiation area 50, where the beam B is irradiated. The irradiation area 50 moves along an irradiation path 5. The irradiation area 50 and the irradiation path 5 will be described in detail below. Due to the irradiation of the hardening region 4, the hardening region 4 is heated, for example, to approximately 900° C.

After the heating of the metal member 1 by the beam B is completed, the metal member 1 is rapidly cooled (i.e., quenched), for example, to approximately 200° C. within a short time. As a result, a martensitic transformation occurs in the hardening region 4 of the metal member 1, and the hardness of the hardening region 4 is improved.

### [1-4. Irradiation Path]

In the hardening step, the beam B is irradiated along the irradiation path 5 set in the hardening region 4 (see FIG. 4). The irradiation path 5 is arranged throughout the entire hardening region 4. The irradiation path 5 includes multiple leftward crossing segments 51, multiple rightward crossing segments 52, and multiple connecting segments 53.

The leftward crossing segments 51 and the rightward crossing segments 52 (hereinafter, simply also referred to as the “crossing segments 51, 52”) are segments that each cross the ridgeline 20. The leftward crossing segments 51 and the rightward crossing segments 52 are alternately arranged from a start point 5S to an end point 5E. The start point 5S and the end point 5E are located on the right side with respect to the ridgeline 20. Each of the crossing segments 51, 52 extends linearly so as to cross the ridgeline 20 at 90°, for example. Each of the crossing segments 51, 52 has approximately the same length. For each of the crossing segments 51, 52, one end is located in one of the two adjacent portions 3L and 3R, and the other end thereof is located in the other of the two adjacent portions 3L and 3R. Both ends of each of the crossing segments 51, 52 are located near edges of the hardening region 4. Specifically, each of the crossing segments 51, 52 crosses a portion forming the effective width be, and both ends of each of the crossing segments 51, 52 are located in portions different from the portion forming the effective width be. The crossing segments 51, 52 are arranged substantially parallel to each other along the ridgeline 20 from the start point 5S toward the end point 5E, spaced from each other at a substantially constant interval (hereinafter, referred to as a “pitch P”).

However, an angle at which each of the crossing segments 51, 52 crosses the ridgeline 20, a length of each of the crossing segments 51, 52, a shape of each of the crossing segments 51, 52, a position of each of the crossing segments 51, 52, or the pitch P may be appropriately determined according to, for example, the shape of the metal member 1 (more specifically, the ridgeline portion 2) or the shape of the hardening region 4. For example, the irradiation path 5 may include multiple leftward crossing segments 51 and multiple rightward crossing segments 52, or may include one leftward crossing segment 51 and one rightward crossing segment 52. The ends of each of the crossing segments 51, 52 may be located in the ridgeline portion 2 on the right side or the left side with respect to the ridgeline 20, not in the adjacent portions 3L and 3R.

The leftward crossing segment 51 includes a first start end 51S, which is an end located on the right side with respect to the ridgeline 20, and a first terminal end 51E, which is an end located on the left side with respect to the ridgeline 20. The rightward crossing segment 52 includes a second start end 52S, which is an end located on the left side with respect to the ridgeline 20, and a second terminal end 52E, which is an end located on the right side with respect to the ridgeline 20.

On the left side with respect to the ridgeline 20, the first terminal end 51E of the leftward crossing segment 51 and the second start end 52S of the rightward crossing segment 52 that is closer to the end point 5E than this leftward crossing segment 51 are connected to each other by the connecting segment 53. On the right side with respect to the ridgeline 20, the second terminal end 52E of the rightward crossing segment 52 and the first start end 51S of another leftward crossing segment 51 that is closer to the end point 5E than this rightward crossing segment 52 are connected to each other by another connecting segment 53.

Since the start point 5S of the irradiation path 5 is located on the right side with respect to the ridgeline 20, the first start end 51S of the leftward crossing segment 51 is located at the start point 5S. However, the start point 5S of the irradiation path 5 may be located on the left side with respect to the ridgeline 20. In this case, the second start end 52S of the rightward crossing segment 52 is located at the start point 5S. Since the end point 5E of the irradiation path 5 is also located on the right side with respect to the ridgeline 20, the second terminal end 52E of the rightward crossing segment 52 is located at the end point 5E. However, the end point 5E of the irradiation path 5 may be located on the left side with respect to the ridgeline 20. In this case, the first terminal end 51E of the leftward crossing segment 51 is located at the end point 5E.

### [1-5. Beam Irradiation]

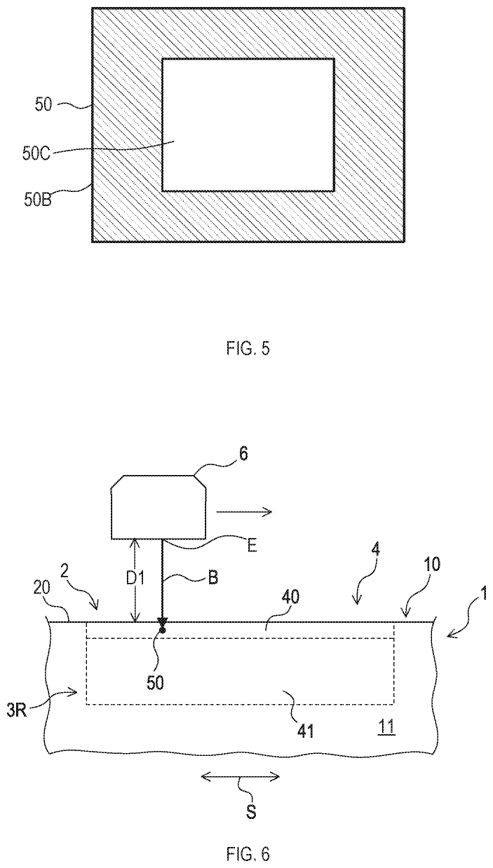

The outer shape of the irradiation area 50 is rectangular when viewed in the shortest direction (see FIG. 5). The irradiation area 50 includes an outer peripheral portion 50B and a central portion 50C. In FIGS. 4, 5, and 7A to 10, the outer peripheral portion 50B is hatched.

The outer peripheral portion 50B is a frame-like portion. An outer peripheral edge and an inner peripheral edge of the outer peripheral portion 50B each have a rectangular shape. The outer peripheral portion 50B defines an outer peripheral edge of the irradiation area 50.

The central portion 50C is surrounded by the outer peripheral portion 50B. The central portion 50C has a rectangular shape. The central portion 50C is in contact with the outer peripheral portion 50B. Specifically, the outer peripheral edge of the central portion 50C is in contact with the inner peripheral edge of the outer peripheral portion 50B over the entire periphery. An intensity of the beam B in the central portion 50C is lower than that of the beam B in the outer peripheral portion 50B. The intensity of the beam B in the central portion 50C may be, for example, zero. In other words, of the outer peripheral portion 50B and the central portion 50C, only the outer peripheral portion 50B may be irradiated with the beam B, but irradiation of the central portion 50C with the beam B may be optional.

As an example, in a case in which a laser beam having a circular cross-sectional shape is emitted from a light source of the laser head 6, the laser head 6 further includes a beam shaper configured to change the shape of the beam B. The laser head 6 changes, by the beam shaper, the circular cross-sectional shape of the laser beam emitted from the light source into a rectangular shape, and emits the rectangular laser beam as the beam B to the outside thereof. Specific examples of the beam shaper include a diffractive optical element (DOE) and a homogenizer. The DOE splits the laser beam emitted from the light source, and the multiple split laser beams are emitted as a single beam B to the outside of the laser head 6. The centers of the split laser beams align along the outer peripheral edge of the outer peripheral portion 50B, so that a rectangular outer shape for the irradiation area 50 is formed.

In the hardening step, the beam B is irradiated from the laser head 6 of the laser device toward the irradiation path 5 in the hardening region 4 (see FIGS. 3 and 4). The emission direction of the beam B, and a relative position between the emission position E of the beam B and the metal member 1 are adjusted so that the irradiation area 50 moves from the start point 5S of the irradiation path 5 to the end point 5E along the irradiation path 5.

Specifically, when the irradiation area 50 moves along the leftward crossing segment 51 or the rightward crossing segment 52, the orientation of the galvanometer mirror 60 is adjusted so that the emission direction of the beam B is changed. Thus, the irradiation area 50 proceeds along the leftward crossing segment 51 from the first start end 51S toward the first terminal end 51E. The irradiation area 50 also proceeds along the rightward crossing segment 52 from the second start end 52S toward the second terminal end 52E.

When the irradiation area 50 moves along the connecting segment 53, the laser head 6 and/or the metal member 1 are moved in a direction parallel to the ridgeline 20 (see FIG. 6). Thus, the irradiation area 50 moves along the connecting segment 53 from the first terminal end 51E of the leftward crossing segment 51 toward the second start end 52S of the rightward crossing segment 52. The irradiation area 50 moves along the connecting segment 53 from the second terminal end 52E of the rightward crossing segment 52 toward the first start end 51S of the leftward crossing segment 51.

For example, movement of the laser head 6 configured as a galvanometer head and/or movement of the metal member 1 may move the irradiation area 50 on each of the crossing segments 51, 52. Also for example, the change of the emission direction of the beam B by the galvanometer mirror 60 may move the irradiation area 50 on the connecting segment 53.

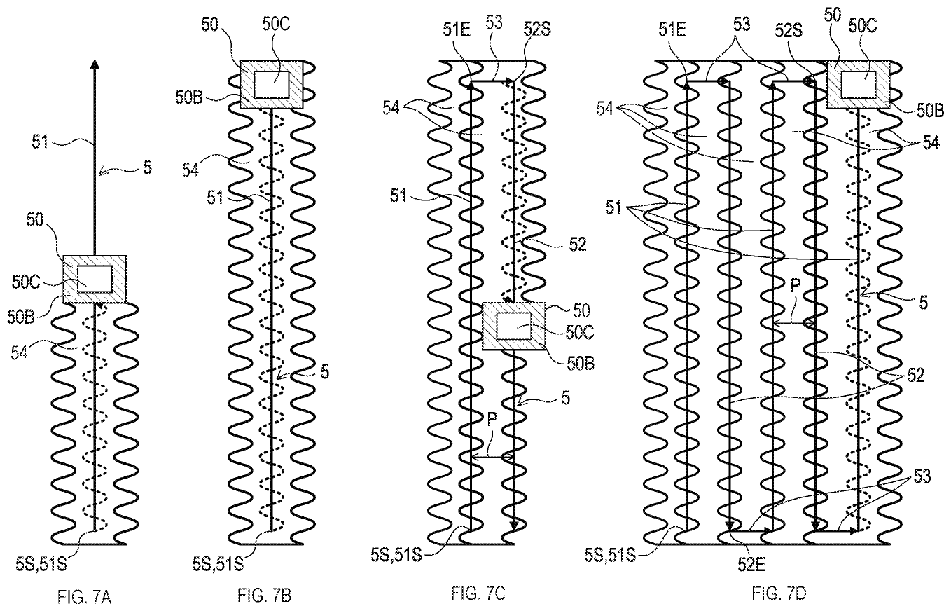

The irradiation area 50 moves along the irradiation path 5 while repeatedly reciprocating in the direction parallel to the ridgeline 20 (see FIG. 4). As an example, a reciprocating speed of the irradiation area 50 in the direction perpendicular to the ridgeline 20 is 4000 mm/s or more and 8000 mm/s or less. Since the irradiation area 50 moves along the irradiation path 5 while repeatedly reciprocating, the center of the irradiation area 50 moves along the irradiation path 5 in a serpentine manner, as indicated by arrows of dotted lines in FIG. 7A to FIG. 7D. A passing region 54 through which the irradiation area 50 has passed is a band-like region extending along the irradiation path 5 in a serpentine manner when viewed in the shortest direction.

The pitch P between the leftward crossing segment 51 and the rightward crossing segment 52 and the size of the irradiation area 50 (as an example, a length of the irradiation area 50 in the direction parallel to the ridgeline 20) are set so that an overlapping region is formed. In the overlapping region, a portion of the passing region 54 formed by the irradiation area 50 passing through the leftward crossing segment 51 and a portion of the passing region 54 formed by the irradiation area 50 passing through the rightward crossing segment 52 overlap with each other. As an example, the pitch P may be 0.05 mm or more and 0.15 mm or less. A length of a side of the irradiation area 50 in the direction parallel to the ridgeline 20 may be 5 mm or more.

### [1-6. Output Power of Beam and Movement Speed of Irradiation Area]

As an example, an output power of the beam B increases as a ridgeline distance D0 (see FIG. 4), which is a distance between the ridgeline 20 and the irradiation area 50, increases. The output power of the beam B may increase as a head distance D1 (see FIGS. 3 and 6), which is a distance between the emission position E of the laser head 6 and the irradiation area 50, increases.

As an example, the movement speed at which the irradiation area 50 moves along the irradiation path 5 decreases as the ridgeline distance D0 increases. The movement speed may decrease as the head distance D1 increases. The movement speed is varied through the adjustment of the speed at which the emission direction of the beam B is changed and the adjustment of the movement speed of the laser head 6 and/or the metal member 1.

The movement speed is set, for example, at two stages. In this case, the hardening region 4 includes a high-speed area 40 and two low-speed areas 41L and 41R. The high-speed area 40 extends from the first end to the second end of the hardening region 4. The high-speed area 40 includes at least the ridgeline 20. The ridgeline 20 is located substantially centrally in left and right directions of the high-speed area 40. The high-speed area 40 is located between the two low-speed areas 41L and 41R from the left and right sides. The low-speed area 41L, one of the two low-speed areas 41L and 41R, is included in the adjacent portion 3L. The low-speed area 41R, the other of the two low-speed areas 41L and 41R, is included in the adjacent portion 3R. The low-speed areas 41L and 41R respectively extend to ends of the crossing segments 51, 52 in the hardening region 4. The low-speed areas 41L and 41R also extend from the first end to the second end of the hardening region 4. The high-speed area 40 and the low-speed areas 41L and 41R each have a rectangular shape when viewed in the shortest direction.

The ridgeline distance D0 and the head distance D1 are longer when the irradiation area 50 moves along the irradiation path 5 located in the low-speed areas 41L and 41R, than when the irradiation area 50 moves along the irradiation path 5 located in the high-speed area 40. The movement speed when the irradiation area 50 passes through the high-speed area 40 is faster than that when the irradiation area 50 passes through the low-speed areas 41L and 41R. As an example, the movement speed of the irradiation area 50 in the high-speed area 40 is 8000 mm/s, and the movement speed of the irradiation area 50 in the low-speed areas 41L and 41R is 4000 mm/s.

The movement speed may be set at N stages (where N is an integer of three or more). Specifically, a high-speed area including the ridgeline 20 may be provided, and N−1 low-speed areas may be provided at both ends of the high-speed area. The movement speed when the irradiation area 50 passes through each low-speed area may be preset, and the movement speed of the irradiation area 50 may decrease as the low-speed area is farther away from the ridgeline 20 (in other words, the high-speed area).

Alternatively, for example, without the high-speed area and the low-speed area, the movement speed of the irradiation area 50 may decrease gradually as the ridgeline distance D0 increases. As the head distance D1 increases, the movement speed of the irradiation area 50 may decrease gradually.

### [1-7. Effects]

According to the first embodiment explained in detail above, the following effects can be obtained.

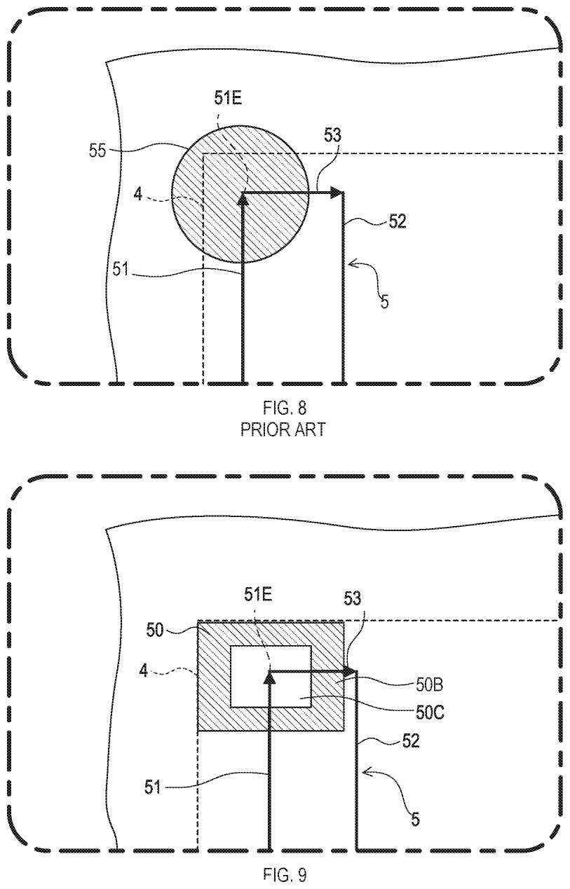

(1a) In the metal member 1, the hardening region 4 has a rectangular shape when viewed in the shortest direction. In manufacturing such a metal member 1, for example, the beam that produces a circular outer shape for the irradiation area 55 when viewed in the shortest direction may be used (see FIG. 8). In this case, there are cases in which an edge of the hardening region 4 cannot be irradiated with the beam B unless the irradiation area 55 extends outside the hardening region 4. If the edge of the hardening region 4 cannot be irradiated with the beam B, a region near the edge of the hardening region 4 can fail to reach the temperature necessary for hardening.

Accordingly, in the method of manufacturing the metal member 1, the beam B that forms the irradiation area 50 having a rectangular outer shape when viewed in the shortest direction is used (see FIG. 9). With this configuration, in the hardening step, the edge of the hardening region 4 can be irradiated with the beam B without the irradiation area 50 extending outside the hardening region 4. Specifically, the entire hardening region 4 can reach the temperature required for hardening without the irradiation area 50 extending outside the hardening region 4. This can reduce an amount of thermal energy corresponding to the beam B that would have been irradiated onto a region not requiring hardening. Therefore, the heating efficiency of hardening can be improved.

(1b) The irradiation area 50 includes the outer peripheral portion 50B and the central portion 50C. The central portion 50C is surrounded by the outer peripheral portion 50B. The intensity of the beam B in the central portion 50C is lower than the intensity of the beam B in the outer peripheral portion 50B. This configuration makes it possible to transfer heat from the outer peripheral portion 50B to the central portion 50C in the hardening region 4. Thus, even when the intensity of the beam B in the central portion 50C is lower than the intensity of the beam B in the outer peripheral portion 50B, both the outer peripheral portion 50B and the central portion 50C can reach the temperature required for hardening. Therefore, for example, as compared to a case in which the intensity of the beam B in the outer peripheral portion 50B and the intensity of the beam B in the central portion 50C are the same, the thermal energy required for hardening can be reduced. Therefore, the heating efficiency of the hardening can be further improved.

(1c) The irradiation area 50 moves along the irradiation path 5 while repeatedly reciprocating in the direction parallel to the ridgeline 20. Specifically, the center of the irradiation area 50 moves along the irradiation path 5 in a serpentine manner. This configuration can shorten the duration during which the same portion within the hardening region 4 is continuously irradiated with the beam B. Thus, localized overheating of the hardening region 4 can be inhibited. Therefore, the hardening region 4 can be hardened more uniformly. Also, damage such as burn-through due to the localized overheating of the hardening region 4 can be inhibited.

(1d) As an example, the output power of the beam B increases as the ridgeline distance D0 increases. The output power of the beam B may increase as the head distance D1 increases. These configurations make it possible to reduce the output power of the beam B in a portion of the hardening region 4 close to the emission position E, but increase the output power of the beam B in a portion of the hardening region 4 distant from the emission position E. That is, the configuration can inhibit excessive hardening in the portion of the hardening region 4 close to the emission position E, and/or insufficient heating in the portion of the hardening region 4 distant from the emission position E. Therefore, the hardening region 4 can be hardened more uniformly. Damage can also be further inhibited.

(1e) As an example, the movement speed of the irradiation area 50 decreases as the ridgeline distance D0 increases. The movement speed of the irradiation area 50 may decrease as the head distance D1 increases. These configurations make it possible to increase the movement speed of the irradiation area 50 in the portion of the hardening region 4 close to the emission position E, but decrease the movement speed of the irradiation area 50 in the portion of the hardening region 4 distant from the emission position E. Therefore, the similar effect as described in (1d) can be obtained.

(1f) The pitch P and the size of the irradiation area 50 are adjusted so that the overlapping region is formed in the passing region 54. As described above, the overlapping region is a region where the portion of the passing region 54 formed by the irradiation area 50 passing through the leftward crossing segment 51 and the portion formed by the irradiation area 50 passing through the rightward crossing segment 52 overlap with each other. This configuration can reduce heating unevenness in the hardening region 4. Therefore, the hardening region 4 can be hardened more uniformly.

(1g) When the overlapping region is formed in the passing region 54 as described above, it is more advantageous that the intensity of the beam B in the central portion 50C of the irradiation area 50 is set to be lower than the intensity of the beam B in the outer peripheral portion 50B as described in (1b). This is because, although the overlapping region is irradiated with the beam B multiple times and the overlapping region may be heated more than necessary, the total amount of heat input to the irradiation area 50 can decrease since the intensity of the beam B in the central portion 50C is lower than that in the outer peripheral portion 50B. As a result, it is possible to inhibit the overlapping region from being heated more than necessary. Consequently, the hardening region 4 can be hardened more uniformly.

(1h) The irradiation path 5 includes the multiple crossing segments 51, 52 that each cross the ridgeline 20. With this configuration, for example, the hardening region 4 can be hardened more uniformly, as compared to cases in which the irradiation path includes only one crossing segment.

(1i) The emission direction of the beam B is changed by the galvanometer mirror 60, thereby moving the irradiation area 50 along the crossing segments 51, 52. With this configuration, the beam B can be suitably irradiated along the crossing segments 51, 52.

(1j) The crossing segments 51, 52 each cross the portion forming the effective width be. With this configuration, the portion forming the effective width be can be hardened more uniformly. Also, damage due to localized overheating of the portion forming the effective width be can be inhibited.

### 2. Second Embodiment

The second embodiment has a basic configuration similar to that of the first embodiment, and differences are described below. The same reference numerals as those used in the first embodiment denote the same configurations and refer to the preceding description.

### [2-1. Beam Irradiation]

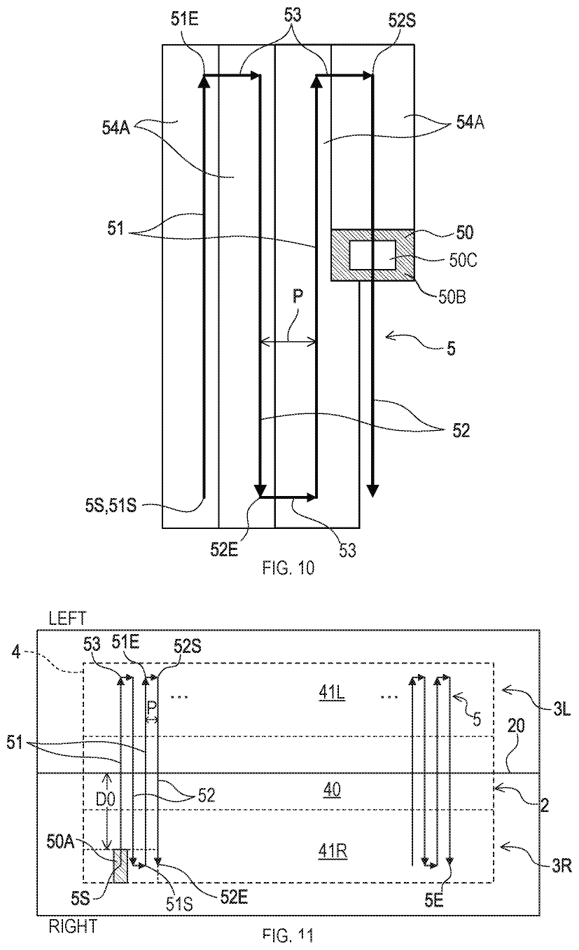

The method of manufacturing the metal member 1 in the second embodiment is generally similar to that of the first embodiment. Specifically, the irradiation area 50 moves along the irradiation path 5 (see FIG. 10). However, the irradiation area 50 moves simply along the irradiation path 5 without reciprocating in the direction parallel to the ridgeline 20. Specifically, the center of the irradiation area 50 moves on the irradiation path 5. Thus, a passing region 54A, through which the irradiation area 50 has passed, is a band-like region extending linearly along the irradiation path 5 when viewed in the shortest direction.

### [2-2. Effects]

According to the second embodiment described in detail above, effects similar to (1a), (1b), and (1d) to (1j) described above can be obtained.

### 3. Other Embodiments

(3a) In the first and second embodiments, the intensity of the beam B in the central portion 50C is lower than the intensity of the beam B in the outer peripheral portion 50B. However, the intensities of the beam B in the central portion 50C and the outer peripheral portion 50B are not particularly limited. For example, the intensity of the beam B may be equal at both of the central portion 50C and the outer peripheral portion 50B to each other. Specifically, as in the modified example, the intensity of the beam B may be constant throughout the entire irradiation area 50A (see FIG. 11). In FIG. 11, the irradiation area 50A is hatched. In the modified example, the irradiation area 50A has a rectangular outer shape elongated in the left and right directions of the hardening region 4.

(3b) In the first and second embodiments, the ridgeline 20 is linear. The ridgeline portion 2 extends linearly along the ridgeline 20 from one end to the other end. However, for example, at least a portion of the ridgeline may be curved. In this case, the ridgeline portion may extend along the ridgeline while being at least partially curved.

(3c) In the first and second embodiments, the metal member 1 is a plate-shaped member. Thus, the ridgeline portion 2 is also plate-shaped, but the shape of the ridgeline portion is not particularly limited. For example, the ridgeline portion may have a three-dimensional shape, such as a prismatic shape, a rounded shape, or a combination thereof. However, even when the ridgeline portion has a shape other than the plate-shaped, the cross section of the ridgeline portion has a curved shape such that the outer peripheral surface of the metal member is convex.

(3d) A function performed by a single component in the aforementioned embodiments may be distributed to a plurality of components, and functions performed by a plurality of components may be achieved by a single component. A part of the configuration of the aforementioned embodiments may be omitted. At least part of the configuration of the aforementioned embodiments may be added to, or replaced with, the configuration of other embodiments described above.

### [Technical Ideas Disclosed in Present Disclosure]

### [Item 1]

A method of manufacturing a metal member, the method comprising:
irradiating a hardening region of the metal member with a beam, wherein
the hardening region includes a ridgeline portion on an outer peripheral surface of the metal member,
the ridgeline portion extends along a ridgeline of the metal member, and a cross section of the ridgeline portion perpendicular to the ridgeline has a curved shape such that the outer peripheral surface is convex, the ridgeline being located at an apex of the cross section,
the hardening region includes therein an irradiation area, where the beam is irradiated, and the irradiation area moves along an irradiation path passing across the ridgeline portion,
the irradiation path includes at least one crossing segment that crosses the ridgeline,
the hardening region has a rectangular shape when viewed in a shortest direction, the shortest direction being a direction along an imaginary straight line connecting a light source of the beam and the ridgeline at a shortest distance, and
the irradiation area has an outer shape that is rectangular when viewed in the shortest direction.

### [Item 2]

The method of manufacturing a metal member according to Item 1, wherein
the irradiation area includes an outer peripheral portion forming an outer peripheral edge of the irradiation area, and a central portion surrounded by the outer peripheral portion, and
an intensity of the beam in the central portion is lower than an intensity of the beam in the outer peripheral portion.

### [Item 3]

The method of manufacturing a metal member according to Item 1 or 2, wherein
the irradiation area moves along the irradiation path while repeatedly reciprocating in a direction parallel to the ridgeline.

### [Item 4]

The method of manufacturing a metal member according to any one of Items 1 to 3, wherein
a speed at which the irradiation area moves decreases as a distance between the ridgeline and the irradiation area increases.

### [Item 5]

The method of manufacturing a metal member according to any one of Items 1 to 4, wherein
an output power of the beam increases as a distance between the ridgeline and the irradiation area increases.

What is claimed is:

1. A method of manufacturing a metal member, the method comprising:
irradiating a hardening region of the metal member with a beam, wherein
the hardening region includes a ridgeline portion on an outer peripheral surface of the metal member,
the ridgeline portion extends along a ridgeline of the metal member, and a cross section of the ridgeline portion perpendicular to the ridgeline has a curved shape such that the outer peripheral surface is convex, the ridgeline being located at an apex of the cross section,
the hardening region includes therein an irradiation area, where the beam is irradiated, and the irradiation area moves along an irradiation path passing across the ridgeline portion,
the irradiation path includes at least one crossing segment that crosses the ridgeline,
the hardening region has a rectangular shape when viewed in a shortest direction, the shortest direction being a direction along an imaginary straight line connecting a light source of the beam and the ridgeline at a shortest distance, and
the irradiation area has an outer shape that is rectangular when viewed in the shortest direction.

2. The method of manufacturing a metal member according to claim 1, wherein
the irradiation area includes an outer peripheral portion forming an outer peripheral edge of the irradiation area, and a central portion surrounded by the outer peripheral portion, and
an intensity of the beam in the central portion is lower than an intensity of the beam in the outer peripheral portion.

3. The method of manufacturing a metal member according to claim 1, wherein
the irradiation area moves along the irradiation path while repeatedly reciprocating in a direction parallel to the ridgeline.

4. The method of manufacturing a metal member according to claim 2, wherein
the irradiation area moves along the irradiation path while repeatedly reciprocating in a direction parallel to the ridgeline.

5. The method of manufacturing a metal member according to claim 1, wherein
a speed at which the irradiation area moves decreases as a distance between the ridgeline and the irradiation area increases.

6. The method of manufacturing a metal member according to claim 2, wherein
a speed at which the irradiation area moves decreases as a distance between the ridgeline and the irradiation area increases.

7. The method of manufacturing a metal member according to claim 1, wherein
an output power of the beam increases as a distance between the ridgeline and the irradiation area increases.

8. The method of manufacturing a metal member according to claim 2, wherein
an output power of the beam increases as a distance between the ridgeline and the irradiation area increases.
